(19) United States
(12) Patent Application Publication
(10) Pub. No.: US 2024/0343996 A1
(43) Pub. Date: Oct. 17, 2024

(54) USE OF ALCOHOL ALKOXYLATE SURFACTANTS FOR IMPROVED DISSOLUTION AND STABILITY IN TABLETED PRODUCTS

(71) Applicant: ECOLAB USA INC., Saint Paul, MN (US)

(72) Inventors: Eileen McIntire, Saint Paul, MN (US); Kelly Anne Rightmire, Saint Paul, MN (US)

(21) Appl. No.: 18/633,061

(22) Filed: Apr. 11, 2024

Related U.S. Application Data
(60) Provisional application No. 63/496,051, filed on Apr. 14, 2023.

(51) Int. Cl. C11D 1/722; C11D 3/00; C11D 3/08; C11D 3/10; C11D 3/20; C11D 3/33; C11D 3/37; C11D 17/00

(52) U.S. Cl. CPC C11D 1/722; C11D 3/0073; C11D 3/08; C11D 3/10; C11D 3/2086; C11D 3/33; C11D 3/3761; C11D 17/0073

(57) ABSTRACT

Solid cleaning compositions having optimal dissolution rate of about 1 gram over 1-10 minutes and stability are disclosed. Solid cleaning compositions contain alcohol alkoxylate surfactants with EO of 6 or less and PO of 2 or greater, an alkalinity source(s), a builder, and optional additional functional ingredients are disclosed. Methods of providing concentrate and/or use solutions of the solid cleaning compositions and methods of use thereof are also provided.

### CROSS REFERENCE TO RELATED APPLICATIONS

This application claims priority under 35 U.S.C. § 119 to provisional application Ser. No. 63/496,051, filed Apr. 14, 2023, herein incorporated by reference in its entirety.

### TECHNICAL FIELD

The disclosure relates to solid cleaning compositions having optimal dissolution rate of about 1 gram over 1-10 minutes and solid stability. In particular, the solid compositions are cleaning compositions that contain alcohol alkoxylate surfactants with EO of 6 or less and PO of 2 or greater, alkalinity source(s), and a builder, and optional additional functional ingredients. Methods of providing concentrate and/or use solutions of the solid cleaning compositions and methods of use thereof are also provided.

### BACKGROUND

Various detergents and cleaning products are commercially available and known in the art. Cleaning products requires both cleaning performance (i.e. removing dirt and soils) and maintaining stable emulsions, suspension and/or solutions for a liquid product. As there are various challenges in transporting and storing liquid cleaning products, in many instances it is desirable to replace liquid formulations with solid cleaning compositions. However, providing solid formulations that have both shelf-stability and readily dissolve to provide liquid use compositions, while maintaining (or exceeding) cleaning performance, is a challenge. In particular providing solid compositions that are readily dissolved into the concentrated liquid use compositions is a challenge.

Accordingly, it is an objective of the compositions to provide solid cleaning compositions that readily dissolve into a liquid concentrate or use solution.

A further objective is to provide stable solid cleaning compositions that provide optimal dissolution into stable ready-to-use formulations.

Other objects, embodiments and advantages of this invention will be apparent to one skilled in the art in view of the following disclosure, the drawings, and the appended claims.

### BRIEF SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present invention to improve on or overcome the deficiencies in the art.

It is a further objective to provide solid cleaning composition comprising: an alkalinity source; an alcohol alkoxylate surfactant having 6 EO or less and greater than 2 PO; and a builder comprising an aminocarboxylic acid, a polycarboxylic acid, an aminophosphonate or combination thereof; wherein the composition readily dissolves into water at a dissolution rate of about 1 gram over 1-10 minutes.

It is a further objective to provide a concentrate or use solution of the compositions as described herein formed by adding the solid composition as described herein to a diluent.

It is a further objective to provide a method of preparing a cleaning composition comprising: adding the solid cleaning composition as described herein to a diluent to dissolve the solid cleaning composition into a concentrate or use solution; wherein the dissolution time for the solid cleaning composition is less than about 20 minutes, or preferably less than about 10 minutes.

It is a further objective to provide a method of cleaning a hard surface comprising: providing the concentrate or use solution of the solid cleaning compositions as described herein to a surface or article in need of cleaning.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

Several embodiments in which the present invention can be practiced are illustrated and described in detail, wherein like reference characters represent like components throughout the several views. The drawings are presented for exemplary purposes and may not be to scale unless otherwise indicated.

FIG. 1 shows a graph comparing the dissolution time of evaluated classes of surfactants showing improvement with alcohol alkoxylate surfactants.

FIG. 2 shows a graph comparing the dissolution time of evaluated alcohol alkoxylate surfactants with varying EO/PO groups showing decrease in dissolution time with decreasing EO groups.

Various embodiments of the present invention will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention. An artisan of ordinary skill in the art need not view, within isolated figure(s), the near infinite number of distinct permutations of features described in the following detailed description to facilitate an understanding of the present invention.

### DETAILED DESCRIPTION OF THE INVENTION

The present disclosure relates to solid cleaning compositions that provide optimal dissolution rates and solid stability while providing cleaning efficacy. The present disclosure is not to be limited to that described herein, which can vary and are understood by skilled artisans. No features shown or described are essential to permit basic operation of the present invention unless otherwise indicated. It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The methods and compositions of the present invention may comprise, consist essentially of, or consist of the components and ingredients of the present invention as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

Unless defined otherwise, all technical and scientific terms used above have the same meaning as commonly understood by one of ordinary skill in the art to which embodiments of the present invention pertain.

The terms “invention” or “present invention” are not intended to refer to any single embodiment of the particular invention but encompass all possible embodiments as described in the specification and the claims.

The term “about,” as used herein, refers to variation in the numerical quantity that can occur, for example, through typical measuring techniques and equipment, with respect to any quantifiable variable, including, but not limited to, mass, volume, time, temperature, pH, and log count of bacteria or viruses. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

As used herein, the term “antimicrobial” refers to a compound or composition that reduces and/or inactivates a microbial population, including, but not limited to bacteria, viruses, fungi, and algae within about 10 minutes or less, about 8 minutes or less, about 5 minutes or less, about 3 minutes or less, about 2 minutes or less, about 1 minute or less, or about 30 seconds or less. Preferably, the term antimicrobial refers to a composition that provides at least about a 3-log, 3.5 log, 4 log, 4.5 log, or 5 log reduction of a microbial population in about 10 minutes or less, about 8 minutes or less, about 5 minutes or less, about 3 minutes or less, about 2 minutes or less, about 1 minute or less, or about 30 seconds or less.

As used herein, the term “cleaning” refers to a method used to facilitate or aid in soil removal, bleaching, microbial population reduction, and any combination thereof. As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

As used herein, the term “exemplary” refers to an example, an instance, or an illustration, and does not indicate a most preferred embodiment unless otherwise stated.

As used herein, the phrase “food processing surface” refers to a surface of a tool, a machine, equipment, a structure, a building, or the like that is employed as part of a food processing, preparation, or storage activity. Examples of food processing surfaces include surfaces of food processing or preparation equipment (e.g., slicing, canning, or transport equipment, including flumes), of food processing wares (e.g., utensils, dishware, wash ware, and bar glasses), and of floors, walls, or fixtures of structures in which food processing occurs. Food processing surfaces are found and employed in food anti-spoilage air circulation systems, aseptic packaging sanitizing, food refrigeration and cooler cleaners and sanitizers, ware washing sanitizing, blancher cleaning and sanitizing, food packaging materials, cutting board additives, third-sink sanitizing, beverage chillers and warmers, meat chilling or scalding waters, autodish sanitizers, sanitizing gels, cooling towers, food processing antimicrobial garment sprays, and non-to-low-aqueous food preparation lubricants, oils, and rinse additives.

The term “generally” encompasses both “about” and “substantially.”

The term “hard surface” refers to a solid, substantially non-flexible surface such as a counter top, tile, floor, wall, panel, window, plumbing fixture, kitchen and bathroom furniture, appliance, engine, circuit board, dish, mirror, window, monitor, touch screen, and thermostat. Hard surfaces are not limited by the material; for example, a hard surface can be glass, metal, tile, vinyl, linoleum, composite, wood, plastic, etc. Hard surfaces may include for example, health care surfaces and food processing surfaces.

As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x”mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

The “scope” of the present invention is defined by the appended claims, along with the full scope of equivalents to which such claims are entitled. The scope of the invention is further qualified as including any possible modification to any of the aspects and/or embodiments disclosed herein which would result in other embodiments, combinations, subcombinations, or the like that would be obvious to those skilled in the art.

As used herein, the term “soil” or “stain” refers to any soil, including, but not limited to, non-polar oily and/or hydrophobic substances which may or may not contain particulate matter such as industrial soils, mineral clays, sand, natural mineral matter, carbon black, graphite, kaolin, environmental dust, and/or food based soils such as blood, proteinaceous soils, starchy soils, fatty soils, cellulosic soils, etc.

The term “substantially” refers to a great or significant extent. “Substantially” can thus refer to a plurality, majority, and/or a supermajority of said quantifiable variable, given proper context.

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

The term “surfactant” or “surface active agent” refers to an organic chemical that when added to a liquid changes the properties of that liquid at a surface.

As used herein, the term “ware” refers to items such as eating and cooking utensils, dishes, and other hard surfaces such as showers, sinks, toilets, bathtubs, countertops, windows, mirrors, transportation vehicles, and floors. As used herein, the term “warewashing” refers to washing, cleaning, or rinsing ware. Ware also refers to items made of plastic. Types of plastics that can be cleaned with the compositions according to the invention include but are not limited to, those that include polypropylene polymers (PP), polycarbonate polymers (PC), melamine formaldehyde resins or melamine resin (melamine), acrylonitrile-butadiene-styrene polymers (ABS), and polysulfone polymers (PS). Other exemplary plastics that can be cleaned using the compounds and compositions of the invention include polyethylene terephthalate (PET) polystyrene polyamide.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “10 wt-%,” etc.

### Solid Cleaning Compositions

According to embodiments, the solid cleaning compositions include the alcohol alkoxylate surfactant, alkalinity source, builder, and optionally an acid source, additional surfactants and/or additional functional ingredients. Exemplary solid cleaning compositions are shown in Tables 1A-1C in weight percentages. While the components may have a percent actives of 100%, it is noted that Tables 1A-1C do not recite the percent actives of the components, but rather, recites the total weight percentage of the raw materials (i.e. active concentration plus inert ingredients).

TABLE 1A

| | First | Second | Third |
|---|---|---|---|
| | Exemplary | Exemplary | Exemplary |
| Material | Range wt.-% | Range wt.-% | Range wt.-% |
| Alkalinity source | 10-75 | 20-75 | 40-75 |
| Alcohol alkoxylate | 1-20 | 2-20 | 3-20 |
| surfactant | | | |
| Builder | 0.1-50 | 1-40 | 5-20 |
| Additional Functional | 0-80 | 0-60 | 0-40 |
| Ingredients | | | |

TABLE 1B

| | First | Second | Third |
|---|---|---|---|
| | Exemplary | Exemplary | Exemplary |
| Material | Range wt.-% | Range wt.-% | Range wt.-% |
| Alkalinity source | 10-75 | 20-75 | 40-75 |
| Alcohol alkoxylate | 1-20 | 2-20 | 3-20 |
| surfactant | | | |
| Builder | 0.1-50 | 1-40 | 5-20 |
| Acid Source | 1-75 | 10-75 | 15-60 |
| Additional Surfactant | 0.1-20 | 1-20 | 1-10 |
| or Polymer(s) | | | |
| Additional Functional | 0-80 | 0-60 | 0-40 |
| Ingredients | | | |

The solid cleaning compositions are solid concentrates that are diluted to form use compositions. In general, a concentrate refers to a composition that is intended to be diluted with water to provide a use solution that contacts an object to provide the desired cleaning, sanitizing, or the like. The solid cleaning composition that contacts the articles to be washed can be referred to as a concentrate or a use composition (or use solution) dependent upon the formulation employed in methods. It should be understood that the concentration of the components in the solid cleaning compositions will vary depending on the concentrated nature of the formulation and the desired use solution thereof.

The solid cleaning compositions provide shelf stable solid compositions. The solid hard surface cleaning compositions are shelf stable, including at elevated storage temperatures and humidity, including for example at temperatures up to at least 50° C. (or 100° F.) for at least 8 weeks with no change in dimension, no weeping (i.e. liquid leaching from solid or visible on the surface of the solid) and/or other visual signs of instability (e.g. cracks, blooming, or any user observations indicating instability). The stability of the solid compositions, namely tablets, are important for maintained dissolution rates at use as the acid and/or alkalinity sources are not prematurely reacting which would negatively impact the optimal dissolution rate.

Beneficially the solid compositions are shelf stability at room temperature or ambient temperatures for at least about 1 year for tablet compositions. It is a significant benefit for the solid cleaning compositions to exhibit both solid stability and use composition stability for extended periods of time.

In some embodiments, a ready-to-use solution of the solid cleaning concentrate diluted to form a use composition is shelf stable, or has a shelf-life, of one day, or more than one day, or more than one week, or more than two weeks. In an embodiment, the ready-to-use diluted form of the solid compositions have a shelf-life of about two weeks.

In some aspects, the solid compositions when diluted to form a use composition have a pH below about 12.5, pH between about 5 and about 10.5, or between about 8 and about 10.

### Alkalinity Source

The solid cleaning composition includes an effective amount of one or more alkalinity sources to enhance cleaning of a substrate and improve soil removal performance at a use pH of less than about 12.5, or between about 8 and about 10.5. In some embodiments a preferred pH is less than about 10.5 to provide a personal protective equipment free (PPE-free) composition. The solid cleaning compositions include between about 10 wt-% and about 75 wt-%, about 20 wt-% and about 75 wt-%, about 30 wt-% and about 75 wt-%, about 40 wt-% and about 75 wt-%, or about 50 wt-% and about 75 wt-% of the alkalinity source(s).

Examples of suitable alkaline sources for the solid hard surface cleaning compositions include, but are not limited to an alkali metal carbonates, bicarbonate, sesquicarbonate, percarbonates, and mixtures thereof. Exemplary alkali metal carbonates that can be used include, but are not limited to sodium or potassium carbonate, bicarbonate, sesquicarbonate, and mixtures thereof. Additional alkalinity sources include, for example, alkali metal silicates such as sodium or potassium silicate or metasilicate; metal carbonates such as sodium or potassium carbonate, bicarbonate, sesquicarbonate; metal borates such as sodium or potassium borate; and ethanolamines and amines.

An additional example of a suitable alkaline source for the solid hard surface cleaning compositions includes alkali metal percarbonates such as sodium percarbonate and/or a modified anhydrous percarbonate, or an expanded percarbonate salt can also be used as an alkalinity source and a carrier. Expanded percarbonate is an absorbent base that is useful for absorbing liquid ingredients. The absorption capacity and the ability to absorb larger weights of liquid depends on the carrier's mass, bulk density and porosity. The modified anhydrous percarbonate salt can have a bulk density of about 0-.62 to 0.7 g/mL and a hydrogen peroxide content of about 0.1 wt-% to less than 24 wt-%. In some preferred embodiments, the modified anhydrous percarbonate salt is a dry solid powder. In some embodiments, a modified anhydrous percarbonate salt is a percarbonate salt with less than about 24 wt-% of hydrogen peroxide. Beneficially the modified anhydrous percarbonate salt can load liquids onto the compound and in embodiments can absorb liquid in an amount up to (or hold up to) about 80 wt-% thereof. Additional disclosure of modified anhydrous percarbonate salts is disclosed in U.S. Pat. No. 8,652,434 the contents of which are incorporated herein by reference in their entirety.

Preferred solid cleaning compositions do not include any alkali metal hydroxides, including for example potassium or sodium hydroxide and are comprised of alkali metal carbonate, alkali metal bicarbonate and/or alkali metal silicates.

### Alcohol Alkoxylate Surfactants

The solid cleaning composition includes an alcohol alkoxylate surfactant. The solid cleaning compositions include between about 1 wt-% and about 40 wt-%, about 1 wt-% and about 20 wt-%, about 2 wt-% and about 20 wt-%, or about 3 wt-% and about 20 wt-% of the alcohol alkoxylate surfactant. In embodiments the nonionic alcohol alkoxylate surfactants provide optimal dissolution of the solid compositions.

In an embodiment nonionic surfactants for the compositions include alcohol alkoxylates, alcohol ethoxylates, EO/PO block copolymers, and the like.

In general alcohol alkoxylates have the following structure: R—O-(EO)ₘ-(PO)ₙ where R is a hydrogen, alkyl, alkenyl or other aliphatic group, or an alkyl-aryl group of from 8 to 20, EO is oxyethylene, PO is oxypropylene, and m and n are independently integers in the range of 1 to 20. For example a commercially available alcohol alkoxylate, such as Dehypon LS-54 (R—O-(EO)₅(PO)₄ where R is C12-C14) and Dehypon LS-36 (R—O-(EO)₃(PO)₆ where R is C12-C14).

In preferred embodiments described herein the alcohol alkoxylates are preferably low EO (referring to number of oxyethylene groups) and high PO (referring to number of oxypropylene groups). As referred to herein, low EO includes 6 EO or less, including 1 EO to 6 EO, and high PO includes greater than 1 PO, preferably 2 PO or more, 4 PO or more, or from 4 PO to 10 PO.

Further exemplary alcohol alkoxylates are shown in Table 2.

TABLE 2

| | | |
|---|---|---|
| Surfactant A | R¹—O—(EO)ₓ₃(PO)_{y3}—H | wherein R¹ is a straight-chain C₁₀- |
| | | C₁₆ alkyl, wherein x₄ is from 5 to 8, |
| | | and wherein y₃ is from 2 to 5 |
| Surfactant A2 | R¹—O—(EO)ₓ₄(PO)_{y4}—H | wherein R¹ is a straight-chain C₁₀- |
| | | C₁₆ alkyl, wherein x₄ is from 4 to 6, |
| | | and wherein y₄ is from 3 to 5 |
| Surfactant B | R²—O—(EO)ₓ₁—H | wherein R² is C₁₀-C₁₆ alkyl with an |
| | | average of at least 2 branches per |
| | | residue, and wherein x₁ is from 5 to 10 |
| Surfactant C | R²—O—(EO)ₓ₂—H | wherein R² is C₁₀-C₁₄ alkyl with an |
| | | average of at least 2 branches per |
| | | residue, and wherein x₂ is from 2 to 4 |
| Surfactant D | R⁷—O—(PO)y₅(EO)x₅(PO)y₆—H | wherein R⁷ is a branched C₈-C₁₆ |
| | | Guerbet alcohol, x₅ is from 5 to 30, |
| | | y₅ is from 1 to 4, and y₆ is from 10 |
| | | to 20 |
| Surfactant E | R⁶—O—(PO)y₄(EO)x₄—H | wherein R⁶ is a C₈-C₁₆ Guerbet |
| | (R⁶ is C₈-C₁₆-guerbet) | alcohol, wherein x₄ is from 2 to 10, |
| | | and wherein y₄ is from 1 to 2, |

### Builder

The solid cleaning compositions include at least one builder, which can include chelant or chelating agent or a water conditioning polymer. Various builders can be employed as water conditioning agents to coordinate (i.e., bind) the metal ions commonly found in natural water to prevent the metal ions from interfering with the action of the other detersive ingredients of a cleaning composition. In general, chelants can generally be referred to as a type of builder and may also function as a threshold agent when included in an effective amount.

The solid cleaning compositions include between about 0.1 wt-% and about 50 wt-%, about 1 wt-% and about 50 wt-%, about 1 wt-% and about 40 wt-%, about 5 wt-% and about 20 wt-%, or about 10 wt-% and about 20 wt-% of the builder(s).

A preferred builder is an aminocarboxylic acid chelant including, for example, methylglycinediacetic acid (MGDA), N, N-dicarboxymethyl glutamic acid (GLDA), N-hydroxyethyliminodiacetic acid, nitrilotriacetic acid (NTA), ethylenediaminetetraacetic acid (EDTA), N-hydroxyethyl-ethylenediaminetriacetic acid (HEDTA), diethylenetriaminepentaacetic acid (DTPA), ethylenediaminetetraproprionic acid, triethylenetetraaminehexaacetic acid (TTHA), and the respective alkali metal, ammonium and substituted ammonium salts thereof.

Additional builders include: phosphonates, including phosphonic acid; phosphates, including condensed phosphates such as sodium and potassium orthophosphate, sodium and potassium pyrophosphate, sodium tripolyphosphate, sodium hexametaphosphate, and the like; organic chelating agents, including both polymeric and small molecule chelating agents such as organocarboxylate compounds or organophosphate chelating agents; polymeric chelating agents, including polyanionic compositions such as polyacrylic acid compounds.

The builder may also be a polymer including for example water soluble polycarboxylate polymers such as homopolymeric and copolymeric compositions with pendant (—COOH) carboxylic acid groups and include polyacrylic acid, polymethacrylic acid, polymaleic acid, acrylic acid-methacrylic acid copolymers, acrylic-maleic copolymers, hydrolyzed polyacrylamide, hydrolyzed methacrylamide, hydrolyzed acrylamide-methacrylamide copolymers, hydrolyzed polyacrylonitrile, hydrolyzed polymethacrylonitrile, hydrolyzed acrylonitrile methacrylonitrile copolymers, or mixtures thereof. Water soluble salts or partial salts of these polymers or copolymers such as their respective alkali metal (for example, sodium or potassium) or ammonium salts can also be used. The weight average molecular weight of the polymers is from about 400 to about 20,000 g/mol. An example of commercially available polycarboxylic acids (polycarboxylates) is ACUSOL 445 which is a homopolymer of acrylic acid with an average molecular weight of 4500 (Dow Chemicals). ACUSOL 445 is available as partially neutralized, liquid detergent polymer.

Exemplary polymers include polyacrylic acid, the partial sodium salts of polyacrylic acid or sodium polyacrylate having an average molecular weight within the range of 4000 to 8000. Further exemplary polymers include polycarboxylates, such as polyacrylic acid, maleic/olefin copolymer, acrylic/maleic copolymer, polymethacrylic acid, acrylic acid-methacrylic acid copolymers, hydrolyzed polyacrylamide, hydrolyzed polymethacrylamide, hydrolyzed polyamide-methacrylamide copolymers, hydrolyzed polyacrylonitrile, hydrolyzed polymethacrylonitrile, and hydrolyzed acrylonitrile-methacrylonitrile copolymers.

In an exemplary embodiment the builder includes an aminocarboxylic acid that is one or more of methylglycinediacetic acid (MGDA), N-hydroxyethyliminodiacetic acid, nitrilotriacetic acid (NTA), ethylenediaminetetraacetic acid (EDTA), N-hydroxyethyl-ethylenediaminetriacetic acid (HEDTA), diethylenetriaminepentaacetic acid (DTPA), ethylenediaminetetraproprionic acid, and triethylenetetraaminehexaacetic acid, and a further builder or water conditioning polymer that is a homopolymer of acrylic acid.

### Acid Source

In preferred embodiments the solid cleaning composition includes an acid source in an effective amount to aid in dissolution of the solid composition. Without being bound by a particular mechanism of action, the acid source reacts with the alkalinity source in the composition to create effervescence to enhance the rate or speed of the physical break-up of the solid composition. The solid cleaning compositions include between about 0 wt-% and about 75 wt-%, about 1 wt-% and about 75 wt-%, about 10 wt-% and about 75 wt-%, about 15 wt-% and about 75 wt-%, or about 15 wt-% and about 60 wt-% of the acid(s).

As referred to herein the solid composition comprises an acid or salt thereof. Preferably the acid has an aqueous solubility between 0.1 g/L and 1500 g/L at 20° C., more preferably between 0.25 g/L and 500 g/L at 20° C., most preferably between 0.25 and 100 g/L at 20° C. As used herein, the g/L description refers to the mass of acid added with sufficient aqueous medium (e.g., water) to form one liter of solution.

Preferably the acid is a polycarboxylic acid. More preferably, the acid is a polycarboxylic acid having between 2 and 4 carboxyl groups. More preferably the polycarboxylic acid is a dicarboxylic acid or a tricarboxylic acid. Preferred acids include, but are not limited to, citric acid, adipic acid, ethylenediamine tetra acetic acid, isocitric acid, glutamic acid, glutaric acid, malic acid, propane-1,2,3-tricarboxylic acid, succinic acid, tartaric acid, salts of the foregoing, and mixtures thereof.

In an embodiment the acid is adipic acid and provides desired tablet stability. In a further embodiment the acid is citric acid and provides a desired balance of tablet stability and dissolution rate.

### Additional Surfactants

The solid cleaning compositions can optionally include additional surfactants for desired cleaning performance with the optimal dissolution rates. Various surfactants can be employed to provide performance and dissolution. Preferred surfactants suitable for use with the compositions include, but are not limited to, amphoteric (including zwitterionic), anionic and/or additional nonionic surfactants. The solid cleaning compositions can optionally include between about 0 wt-% and about 30 wt-%, about 0.1 wt-% and about 30 wt-%, about 1 wt-% and about 20 wt-%, or about 1 wt-% and about 10 wt-% of the additional surfactants.

In some embodiments additional surfactants are provided for cleaning efficacy. In embodiments an amphoteric surfactant is a desirable cleaning surfactant.

### Amphoteric Surfactants

Amphoteric, or ampholytic, surfactants contain both a basic and an acidic hydrophilic group and an organic hydrophobic group. These ionic entities may be any of anionic or cationic groups described herein for other types of surfactants. A basic nitrogen and an acidic carboxylate group are the typical functional groups employed as the basic and acidic hydrophilic groups. In a few surfactants, sulfonate, sulfate, phosphonate or phosphate provide the negative charge.

Amphoteric surfactants can be broadly described as derivatives of aliphatic secondary and tertiary amines, in which the aliphatic radical may be straight chain or branched and wherein one of the aliphatic substituents contains from about 8 to 18 carbon atoms and one contains an anionic water solubilizing group, e.g., carboxy, sulfo, sulfato, phosphato, or phosphono. Amphoteric surfactants are subdivided into two major classes known to those of skill in the art and described in “Surfactant Encyclopedia” Cosmetics & Toiletries, Vol. 104 (2) 69-71 (1989), which is herein incorporated by reference in its entirety. The first class includes acyl/dialkyl ethylenediamine derivatives (e.g. 2-alkyl hydroxyethyl imidazoline derivatives) and their salts. The second class includes N-alkylamino acids and their salts. Some amphoteric surfactants can be envisioned as fitting into both classes.

Amphoteric surfactants can be synthesized by methods known to those of skill in the art. For example, 2-alkyl hydroxyethyl imidazoline is synthesized by condensation and ring closure of a long chain carboxylic acid (or a derivative) with dialkyl ethylenediamine. Commercial amphoteric surfactants are derivatized by subsequent hydrolysis and ring-opening of the imidazoline ring by alkylation for example with chloroacetic acid or ethyl acetate. During alkylation, one or two carboxy-alkyl groups react to form a tertiary amine and an ether linkage with differing alkylating agents yielding different tertiary amines. Long chain imidazole derivatives generally have the general formula:

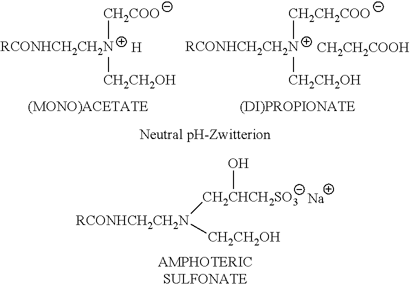

wherein R is an acyclic hydrophobic group containing from about 8 to 18 carbon atoms and M is a cation to neutralize the charge of the anion, generally sodium. Commercially prominent imidazoline-derived amphoterics that can be employed in the present compositions include for example: Cocoamphopropionate, Cocoamphocarboxy-propionate, Cocoamphoglycinate, Cocoamphocarboxy-glycinate, Cocoamphopropyl-sulfonate, and Cocoamphocarboxy-propionic acid. Amphocarboxylic acids can be produced from fatty imidazolines in which the dicarboxylic acid functionality of the amphodicarboxylic acid is diacetic acid and/or dipropionic acid.

The carboxymethylated compounds (glycinates) described herein above frequently are called betaines. Betaines are a special class of amphoteric discussed herein below in the section entitled, Zwitterion Surfactants.

Long chain N-alkylamino acids are readily prepared by reaction RNH₂, in which R=C₈-C₁₈ straight or branched chain alkyl, fatty amines with halogenated carboxylic acids. Alkylation of the primary amino groups of an amino acid leads to secondary and tertiary amines. Alkyl substituents may have additional amino groups that provide more than one reactive nitrogen center. Most commercial N-alkylamine acids are alkyl derivatives of beta-alanine or beta-N(2-carboxyethyl) alanine. Examples of commercial N-alkylamino acid ampholytes having application in this invention include alkyl beta-amino dipropionates, RN(C₂H₄COOM)₂ and RNHC₂H₄COOM. In an embodiment, R can be an acyclic hydrophobic group containing from about 8 to about 18 carbon atoms, and M is a cation to neutralize the charge of the anion.

Suitable amphoteric surfactants include those derived from coconut products such as coconut oil or coconut fatty acid. Additional suitable coconut derived surfactants include as part of their structure an ethylenediamine moiety, an alkanolamide moiety, an amino acid moiety, e.g., glycine, or a combination thereof; and an aliphatic substituent of from about 8 to 18 (e.g., 12) carbon atoms. Such a surfactant can also be considered an alkyl amphodicarboxylic acid. These amphoteric surfactants can include chemical structures represented as: C₁₂-alkyl-C(O)—NH—CH₂—CH₂—N⁺(CH₂—CH₂—CO₂Na)₂—CH₂—CH₂—OH or C₁₂-alkyl-C(O)—N(H)—CH₂—CH₂—N⁺(CH₂—CO₂Na)₂—CH₂—CH₂—OH. Disodium cocoampho dipropionate is one suitable amphoteric surfactant and is commercially available under the tradename Miranol™ FBS from Rhodia Inc., Cranbury, N.J. Another suitable coconut derived amphoteric surfactant with the chemical name disodium cocoampho diacetate is sold under the tradename Mirataine™ JCHA, also from Rhodia Inc., Cranbury, N.J.

Additional suitable surfactants include amine oxide surfactants having the formula:

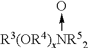

wherein R³ is an alkyl, hydroxyalkyl, or alkyl phenyl group or mixtures thereof containing from about 8 to about 22 carbon atoms; R⁴ is an alkylene or hydroxyalkylene group containing from about 2 to about 3 carbon atoms or mixtures thereof; x is from 0 to about 3; and each R⁵ is an alkyl or hydroxyalkyl group containing from about 1 to about 3 carbon atoms or a polyethylene oxide group containing from about 1 to about 3 ethylene oxide groups. R⁵ groups can be attached to each other, e.g., through an oxygen or nitrogen atom, to form a ring structure. Exemplary amine oxide surfactants are C10-C18 alkyldimethylamine oxides and C8-C12 alkoxyethyldihydroxyethylamine oxides. Further exemplary amine oxides include lauramine oxide, also referred to as Lauryldimethylamine oxide; Lauryldimethylamine N-oxide; Dodecyldimethylamine N-oxide; Dodecyldimethylamine oxide; C₁₄H₃₁NO.

A typical listing of amphoteric classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch).

### Zwitterionic Surfactants

Zwitterionic surfactants are a subset of the amphoteric surfactants and can include an anionic charge. Zwitterionic surfactants can be broadly described as derivatives of secondary and tertiary amines, derivatives of heterocyclic secondary and tertiary amines, or derivatives of quaternary ammonium, quaternary phosphonium or tertiary sulfonium compounds. Typically, a zwitterionic surfactant includes a positive charged quaternary ammonium or, in some cases, a sulfonium or phosphonium ion; a negative charged carboxyl group; and an alkyl group. Zwitterionics generally contain cationic and anionic groups which ionize to a nearly equal degree in the isoelectric region of the molecule and which can develop strong “inner-salt” attraction between positive-negative charge centers. Examples of such zwitterionic synthetic surfactants include derivatives of aliphatic quaternary ammonium, phosphonium, and sulfonium compounds, in which the aliphatic radicals can be straight chain or branched, and wherein one of the aliphatic substituents contains from 8 to 18 carbon atoms and one contains an anionic water solubilizing group, e.g., carboxy, sulfonate, sulfate, phosphate, or phosphonate.

Betaine and sultaine surfactants are exemplary zwitterionic surfactants for use herein. A general formula for these compounds is:

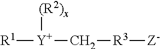

wherein R¹ contains an alkyl, alkenyl, or hydroxyalkyl radical of from 8 to 18 carbon atoms having from 0 to 10 ethylene oxide moieties and from 0 to 1 glyceryl moiety; Y is selected from the group consisting of nitrogen, phosphorus, and sulfur atoms; R² is an alkyl or monohydroxy alkyl group containing 1 to 3 carbon atoms; x is 1 when Y is a sulfur atom and 2 when Y is a nitrogen or phosphorus atom, R³ is an alkylene or hydroxy alkylene or hydroxy alkylene of from 1 to 4 carbon atoms and Z is a radical selected from the group consisting of carboxylate, sulfonate, sulfate, phosphonate, and phosphate groups.

Examples of zwitterionic surfactants having the structures listed above include: 4-[N,N-di(2-hydroxyethyl)-N-octadecylammonio]-butane-1-carboxylate; 5-[S-3-hydroxypropyl-S-hexadecylsulfonio]-3-hydroxypentane-1-sulfate; 3-[P,P-diethyl-P-3,6,9-trioxatetracosanephosphonio]-2-hydroxypropane-1-phosphate; 3-[N,N-dipropyl-N-3-dodecoxy-2-hydroxypropyl-ammonio]-propane-1-phosphonate; 3-(N,N-dimethyl-N-hexadecylammonio)-propane-1-sulfonate; 3-(N,N-dimethyl-N-hexadecylammonio)-2-hydroxy-propane-1-sulfonate; 4-[N,N-di(2(2-hydroxyethyl)-N(2-hydroxydodecyl)ammonio]-butane-1-carboxylate; 3-[S-ethyl-S-(3-dodecoxy-2-hydroxypropyl)sulfonio]-propane-1-phosphate; 3-[P,P-dimethyl-P-dodecylphosphonio]-propane-1-phosphonate; and S[N,N-di(3-hydroxypropyl)-N-hexadecylammonio]-2-hydroxy-pentane-1-sulfate. The alkyl groups contained in said detergent surfactants can be straight or branched and saturated or unsaturated.

The zwitterionic surfactant suitable for use in the present compositions includes a betaine of the general structure:

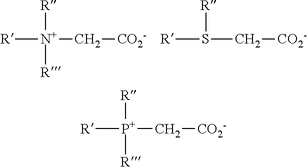

These surfactant betaines typically do not exhibit strong cationic or anionic characters at pH extremes nor do they show reduced water solubility in their isoelectric range. Unlike “external” quaternary ammonium salts, betaines are compatible with anionics. Examples of suitable betaines include coconut acylamidopropyldimethyl betaine; hexadecyl dimethyl betaine; C₁₂₋₁₄ acylamidopropylbetaine; C₈₋₁₄ acylamidohexyldiethyl betaine; 4-C₁₄₋₁₆ acylmethylamidodiethylammonio-1-carboxybutane; C₁₆₋₁₈ acylamidodimethylbetaine; C₁₂₋₁₆ acylamidopentanediethylbetaine; and C₁₂₋₁₆ acylmethylamidodimethylbetaine.

Particularly suitable sultaines include those compounds having the formula (R(R¹)₂ N⁺ R²SO³⁻, in which R is a C₆-C₁₈ hydrocarbyl group, each R¹ is typically independently C₁-C₃ alkyl, e.g. methyl, and R² is a C₁-C₆ hydrocarbyl group, e.g. a C₁-C₃ alkylene or hydroxyalkylene group.

A typical listing of zwitterionic classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch). Each of these references is herein incorporated in their entirety.

In an embodiment, the solid hard surface cleaning compositions include an amine oxide and/or a betaine and/or a sultaine.

### Anionic Surfactants

The solid cleaning compositions can include at least one anionic surfactant as an additional surfactant for cleaning efficacy. Anionics are those having a negative charge on the hydrophobe; or surfactants in which the hydrophobic section of the molecule carries no charge unless the pH is elevated to neutrality or above (e.g., carboxylic acids). Carboxylate, sulfonate, sulfate and phosphate are the polar (hydrophilic) solubilizing groups found in anionic surfactants. Of the cations (counter ions) associated with these polar groups, sodium, lithium and potassium impart water solubility; ammonium and substituted ammonium ions provide both water and oil solubility; and calcium, barium, and magnesium promote oil solubility. As those skilled in the art understand, anionics are excellent detersive surfactants and are therefore favored additions to heavy duty cleaning compositions.

Anionic sulfate surfactants suitable for use in the compositions include alkyl ether sulfates, alkyl sulfates, the linear and branched primary and secondary alkyl sulfates, alkyl ethoxysulfates, fatty oleyl glycerol sulfates, alkyl phenol ethylene oxide ether sulfates, the C₅-C₁₇ acyl-N—(C₁-C₄ alkyl) and —N—(C₁-C₂ hydroxyalkyl) glucamine sulfates, and sulfates of alkylpolysaccharides such as the sulfates of alkylpolyglucoside, and the like. Also included are the alkyl sulfates, alkyl poly(ethyleneoxy) ether sulfates and aromatic poly(ethyleneoxy) sulfates such as the sulfates or condensation products of ethylene oxide and nonyl phenol (usually having 1 to 6 oxyethylene groups per molecule). Anionic sulfonate surfactants suitable for use also include alkyl sulfonates, the linear and branched primary and secondary alkyl sulfonates, and the aromatic sulfonates with or without substituents.

Anionic carboxylate surfactants suitable for use include carboxylic acids (and salts), such as alkanoic acids (and alkanoates), ester carboxylic acids (e.g., alkyl succinates, such as sodium dioctyl sulfosuccinate), ether carboxylic acids, sulfonated fatty acids, such as sulfonated oleic acid, and the like. Such carboxylates include alkyl ethoxy carboxylates, alkyl aryl ethoxy carboxylates, alkyl polyethoxy polycarboxylate surfactants and soaps (e.g., alkyl carboxyls). Secondary carboxylates useful in the present compositions include those which contain a carboxyl unit connected to a secondary carbon. The secondary carbon can be in a ring structure, e.g., as in p-octyl benzoic acid, or as in alkyl-substituted cyclohexyl carboxylates. The secondary carboxylate surfactants typically contain no ether linkages, no ester linkages and no hydroxyl groups. Further, they typically lack nitrogen atoms in the head-group (amphiphilic portion). Suitable secondary soap surfactants typically contain 11-13 total carbon atoms, although more carbons atoms (e.g., up to 16) can be present. Suitable carboxylates also include acylamino acids (and salts), such as acylgluamates, acyl peptides, sarcosinates (e.g., N-acyl sarcosinates), taurates (e.g., N-acyl taurates and fatty acid amides of methyl tauride), and the like.

Suitable anionic surfactants include alkyl or alkylaryl ethoxy carboxylates of the following formula: R=O—(CH₂CH₂O)ₙ(CH₂)ₘ—CO₂X (3) in which R is a C₈ to C₂₂ alkyl group or

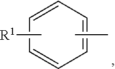

in which R¹ is a C₄-C₁₆ alkyl group; n is an integer of 1-20; m is an integer of 1-3; and X is a counter ion, such as hydrogen, sodium, potassium, lithium, ammonium, or an amine salt such as monoethanolamine, diethanolamine or triethanolamine. In some embodiments, n is an integer of 4 to 10 and m is 1. In some embodiments, R is a C₈-C₁₆ alkyl group. In some embodiments, R is a C₁₂-C₁₄ alkyl group, n is 4, and m is 1.

In other embodiments, R is

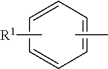

and R¹ is a C₆-C₁₂ alkyl group. In still yet other embodiments, R¹ is a C₉ alkyl group, n is 10 and m is 1.

### Additional Nonionic Surfactants

The solid cleaning compositions can include an additional nonionic surfactant for cleaning and/or dissolution. Useful nonionic surfactants are generally characterized by the presence of an organic hydrophobic group and an organic hydrophilic group and are typically produced by the condensation of an organic aliphatic, alkyl aromatic or polyoxyalkylene hydrophobic compound with a hydrophilic alkaline oxide moiety which in common practice is ethylene oxide or a polyhydration product thereof, polyethylene glycol. Practically any hydrophobic compound having a hydroxyl, carboxyl, amino, or amido group with a reactive hydrogen atom can be condensed with ethylene oxide, or its polyhydration adducts, or its mixtures with alkoxylenes such as propylene oxide to form a nonionic surface-active agent. The length of the hydrophilic polyoxyalkylene moiety which is condensed with any particular hydrophobic compound can be readily adjusted to yield a water dispersible or water soluble compound having the desired degree of balance between hydrophilic and hydrophobic properties. Useful nonionic surfactants include:

Polyethylene glycols (PEG) are products of condensed ethylene oxide and water that can have various derivatives and functions. PEGs are composed of polyether compounds repeating ethylene glycol units according to the constituent monomer or parent molecule (as ethylene glycol, ethylene oxide, or oxyethylene) as shown

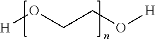

wherein n is any integer of at least 1. Preferably the PEG coating surfactant is a short chain PEG 200-800, such as PEG 200, PEG 400, PEG 600, or PEG 800.

Block polyoxypropylene-polyoxyethylene polymeric compounds based upon propylene glycol, ethylene glycol, glycerol, trimethylolpropane, and ethylenediamine as the initiator reactive hydrogen compound. Examples of polymeric compounds made from a sequential propoxylation and ethoxylation of initiator are commercially available from BASF Corp. One class of compounds are difunctional (two reactive hydrogens) compounds formed by condensing ethylene oxide with a hydrophobic base formed by the addition of propylene oxide to the two hydroxyl groups of propylene glycol. This hydrophobic portion of the molecule weighs from about 1,000 to about 4,000. Ethylene oxide is then added to sandwich this hydrophobe between hydrophilic groups, controlled by length to constitute from about 10% by weight to about 80% by weight of the final molecule. Another class of compounds are tetra-functional block copolymers derived from the sequential addition of propylene oxide and ethylene oxide to ethylenediamine. The molecular weight of the propylene oxide hydrotype ranges from about 500 to about 7,000; and, the hydrophile, ethylene oxide, is added to constitute from about 10% by weight to about 80% by weight of the molecule.

Condensation products of one mole of alkyl phenol wherein the alkyl chain, of straight chain or branched chain configuration, or of single or dual alkyl constituent, contains from about 8 to about 18 carbon atoms with from about 3 to about 50 moles of ethylene oxide. The alkyl group can, for example, be represented by diisobutylene, di-amyl, polymerized propylene, iso-octyl, nonyl, and di-nonyl. These surfactants can be polyethylene, polypropylene, and polybutylene oxide condensates of alkyl phenols. Examples of commercial compounds of this chemistry are available on the market under the trade names Igepal® manufactured by Rhone-Poulenc and Triton® manufactured by Union Carbide.

Condensation products of one mole of a saturated or unsaturated, straight or branched chain alcohol having from about 6 to about 24 carbon atoms with from about 3 to about 50 moles of ethylene oxide. The alcohol moiety can consist of mixtures of alcohols in the above delineated carbon range or it can consist of an alcohol having a specific number of carbon atoms within this range. Examples of like commercial surfactant are available under the trade names Lutensol™, Dehydol™ manufactured by BASF, Neodol™ manufactured by Shell Chemical Co. and Alfonic™ manufactured by Vista Chemical Co.

Condensation products of one mole of saturated or unsaturated, straight or branched chain carboxylic acid having from about 8 to about 18 carbon atoms with from about 6 to about 50 moles of ethylene oxide. The acid moiety can consist of mixtures of acids in the above defined carbon atoms range or it can consist of an acid having a specific number of carbon atoms within the range. Examples of commercial compounds of this chemistry are available on the market under the trade names Disponil or Agnique manufactured by BASF and Lipopeg™ manufactured by Lipo Chemicals, Inc.

In addition to ethoxylated carboxylic acids, commonly called polyethylene glycol esters, other alkanoic acid esters formed by reaction with glycerides, glycerin, and polyhydric (saccharide or sorbitan/sorbitol) alcohols have application in this invention for specialized embodiments, particularly indirect food additive applications. All of these ester moieties have one or more reactive hydrogen sites on their molecule which can undergo further acylation or ethylene oxide (alkoxide) addition to control the hydrophilicity of these substances.

Examples of nonionic low foaming surfactants include:

Compounds described herein that are modified, essentially reversed, by adding ethylene oxide to ethylene glycol to provide a hydrophile of designated molecular weight; and, then adding propylene oxide to obtain hydrophobic blocks on the outside (ends) of the molecule. The hydrophobic portion of the molecule weighs from about 1,000 to about 3,100 with the central hydrophile including 10% by weight to about 80% by weight of the final molecule. These reverse PluronicS™ are manufactured by BASF Corporation under the trade name Pluronic™ R surfactants. Likewise, the Tetronic™ R surfactants are produced by BASF Corporation by the sequential addition of ethylene oxide and propylene oxide to ethylenediamine. The hydrophobic portion of the molecule weighs from about 2,100 to about 6,700 with the central hydrophile including 10% by weight to 80% by weight of the final molecule.

Compounds described herein that are modified by “capping” or “end blocking” the terminal hydroxy group or groups (of multi-functional moieties) to reduce foaming by reaction with a small hydrophobic molecule such as propylene oxide, butylene oxide, benzyl chloride; and, short chain fatty acids, alcohols or alkyl halides containing from 1 to about 5 carbon atoms; and mixtures thereof. Also included are reactants such as thionyl chloride which convert terminal hydroxy groups to a chloride group. Such modifications to the terminal hydroxy group may lead to all-block, block-heteric, heteric-block or all-heteric nonionics.

Additional alcohol ethoxylate nonionic surfactants can include polymer surfactants, such as those shown in Table 3.

TABLE 3

| | | |
|---|---|---|
| Surfactant F | 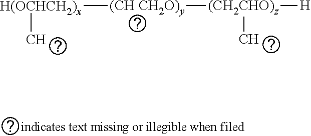 | Where x = 12-20, y = 120-220, z = 12-20 |
| Surfactant G | 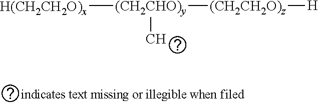 | Where x = 88-108, y = 57-77, z = 88-108 |
| Surfactant H | 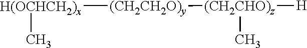 | Where x = 15-25, y = 10-25, z = 15-25 |
| Surfactant I | R⁴—O—(EO)ₓ(XO)_{y}—H | Where R4 = C13-C15 alkyl, |
| | | x = 8-10, y = 1-3, |
| | | and XO = Butylene oxide |
| Surfactant J | R⁵—O—(EO)ₓ(PO)_{y}—H | Where R5 = C12-C15 alkyl, |
| | | x = 3-5, y = 5-7 |

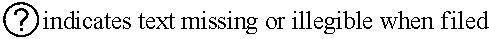

Additional examples of alcohol ethoxylate nonionic surfactants are those that are capped, for example, halogen or benzyl capped.

Some non-limiting examples of commercially available alcohol ethoxylate nonionic surfactants include the following: Surfonic L24-7 available from Huntsman, Dehypon LS 54 available from Henkel; Tomadol 91-6, Tomadol 1-9, Tomadol 1-5, and Tomadol 1-3 available from Tomah; Plurafac D-25, and SLF-18 available from BASF; Sasol C13-9EO, Sasol C8-10-6EO, Sasol TDA C13-6EO, and Sasol C6-10-12EO available from Sasol; Hetoxol 1-20-10 and Hetoxol 1-20-5 available from Laurachem; Huntsman L46-7EO available from Huntman; and Antarox BL 330 and BL 344 available from Rhodia, Pluronic N-3, Plurafac LF-221, Ls-36, Pluronic 25R2, Pluronic 10R5, Novel 1012 GB, Pluronic LD-097, Pluronic D-097, Neodol 25-12. Antarox BL 330 and BL 344 are either branched or straight chain C12-C18 halogen capped alcohol ethoxylate nonionic surfactants.

Additional examples of effective low foaming nonionics include:

The alkylphenoxypolyethoxyalkanols of U.S. Pat. No. 2,903,486 issued Sep. 8, 1959 to Brown et al. and represented by the formula

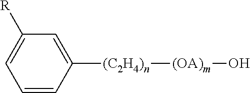

in which R is an alkyl group of 8 to 9 carbon atoms, A is an alkylene chain of 3 to 4 carbon atoms, n is an integer of 7 to 16, and m is an integer of 1 to 10.

The polyalkylene glycol condensates of U.S. Pat. No. 3,048,548 issued Aug. 7, 1962 to Martin et al. having alternating hydrophilic oxyethylene chains and hydrophobic oxypropylene chains where the weight of the terminal hydrophobic chains, the weight of the middle hydrophobic unit and the weight of the linking hydrophilic units each represent about one-third of the condensate.

The defoaming nonionic surfactants disclosed in U.S. Pat. No. 3,382,178 issued May 7, 1968 to Lissant et al. having the general formula Z[(OR)ₙOH]_{z} wherein Z is alkoxylatable material, R is a radical derived from an alkylene oxide which can be ethylene and propylene and n is an integer from, for example, 10 to 2,000 or more and z is an integer determined by the number of reactive oxyalkylatable groups.

The conjugated polyoxyalkylene compounds described in U.S. Pat. No. 2,677,700, issued May 4, 1954 to Jackson et al. corresponding to the formula Y(C₃H₆O)ₙ(C₂H₄O)ₘH wherein Y is the residue of organic compound having from about 1 to 6 carbon atoms and one reactive hydrogen atom, n has an average value of at least about 6.4, as determined by hydroxyl number and m has a value such that the oxyethylene portion constitutes about 10% to about 90% by weight of the molecule.

The conjugated polyoxyalkylene compounds described in U.S. Pat. No. 2,674,619, issued Apr. 6, 1954 to Lundsted et al. having the formula Y[(C₃H₆Oₙ(C₂H₄O)ₘH]ₓ wherein Y is the residue of an organic compound having from about 2 to 6 carbon atoms and containing x reactive hydrogen atoms in which x has a value of at least about 2, n has a value such that the molecular weight of the polyoxypropylene hydrophobic base is at least about 900 and m has value such that the oxyethylene content of the molecule is from about 10% to about 90% by weight. Compounds falling within the scope of the definition for Y include, for example, propylene glycol, glycerine, pentaerythritol, trimethylolpropane, ethylenediamine and the like. The oxypropylene chains optionally, but advantageously, contain small amounts of ethylene oxide and the oxyethylene chains also optionally, but advantageously, contain small amounts of propylene oxide.

Additional conjugated polyoxyalkylene surface-active agents which are advantageously used in the compositions of this invention correspond to the formula: P[(C₃H₆O)ₙ (C₂H₄O)ₘH]ₓ wherein P is the residue of an organic compound having from about 8 to 18 carbon atoms and containing x reactive hydrogen atoms in which x has a value of 1 or 2, n has a value such that the molecular weight of the polyoxyethylene portion is at least about 44 and m has a value such that the oxypropylene content of the molecule is from about 10% to about 90% by weight. In either case the oxypropylene chains may contain optionally, but advantageously, small amounts of ethylene oxide and the oxyethylene chains may contain also optionally, but advantageously, small amounts of propylene oxide.

Polyhydroxy fatty acid amide surfactants suitable for use in the present compositions include those having the structural formula R2CON_{R1}Z in which: R1 is H, C₁-C₄ hydrocarbyl, 2-hydroxy ethyl, 2-hydroxy propyl, ethoxy, propoxy group, or a mixture thereof; R₂ is a C₅-C₃₁ hydrocarbyl, which can be straight-chain; and Z is a polyhydroxyhydrocarbyl having a linear hydrocarbyl chain with at least 3 hydroxyls directly connected to the chain, or an alkoxylated derivative (preferably ethoxylated or propoxylated) thereof. Z can be derived from a reducing sugar in a reductive amination reaction; such as a glycityl moiety.

The alkyl ethoxylate condensation products of aliphatic alcohols with from about 0 to about 25 moles of ethylene oxide are suitable for use in the present compositions. The alkyl chain of the aliphatic alcohol can either be straight or branched, primary or secondary, and generally contains from 6 to 22 carbon atoms. The ethoxylated C₆-C₁₈ fatty alcohols and C₆-C₁₈ mixed ethoxylated and propoxylated fatty alcohols are suitable surfactants for use in the present compositions, particularly those that are water soluble. Suitable ethoxylated fatty alcohols include the C₆-C₁₈ ethoxylated fatty alcohols with a degree of ethoxylation of from 3 to 50.

Suitable nonionic alkylpolysaccharide surfactants, particularly for use in the present compositions include those disclosed in U.S. Pat. No. 4,565,647, Llenado, issued Jan. 21, 1986. These surfactants include a hydrophobic group containing from about 6 to about 30 carbon atoms and a polysaccharide, e.g., a polyglycoside, hydrophilic group containing from about 1.3 to about 10 saccharide units. Any reducing saccharide containing 5 or 6 carbon atoms can be used, e.g., glucose, galactose and galactosyl moieties can be substituted for the glucosyl moieties. (Optionally the hydrophobic group is attached at the 2-, 3-, 4-, etc. positions thus giving a glucose or galactose as opposed to a glucoside or galactoside.) The intersaccharide bonds can be, e.g., between the one position of the additional saccharide units and the 2-, 3-, 4-, and/or 6-positions on the preceding saccharide units.

Fatty acid amide surfactants suitable for use the present compositions include those having the formula: R₆CON(R₇)₂ in which R₆ is an alkyl group containing from 7 to 21 carbon atoms and each R₇ is independently hydrogen, C₁-C₄ alkyl, C₁-C₄ hydroxyalkyl, or —(C₂H₄O)ₓH, where x is in the range of from 1 to 3.

A useful class of non-ionic surfactants include the class defined as alkoxylated amines or, most particularly, alcohol alkoxylated/aminated/alkoxylated surfactants. These non-ionic surfactants may be at least in part represented by the general formulae: R²⁰—(PO)_{S}N-(EO)ₜH, R²⁰—(PO)_{S}N-(EO)ₜH(EO)ₜH, and R²⁰—N(EO)ₜH; in which R²¹ is an alkyl, alkenyl or other aliphatic group, or an alkyl-aryl group of from 8 to 20, preferably 12 to 14 carbon atoms, EO is oxyethylene, PO is oxypropylene, s is 1 to 20, preferably 2-5, t is 1-10, preferably 2-5, and u is 1-10, preferably 2-5. Other variations on the scope of these compounds may be represented by the alternative formula: R²⁰—(PO)_{V}—N[(EO)_{w}H][(EO)_{z}H] in which R²¹ is as defined above, v is 1 to 20 (e.g., 1, 2, 3, or 4 (preferably 2)), and w and z are independently 1-10, preferably 2-5. These compounds are represented commercially by a line of products sold by Huntsman Chemicals as nonionic surfactants. A preferred chemical of this class includes Surfonic™ PEA 25 Amine Alkoxylate.

The treatise Nonionic Surfactants, edited by Schick, M. J., Vol. 1 of the Surfactant Science Series, Marcel Dekker, Inc., New York, 1983 is an excellent reference on the wide variety of nonionic compounds generally employed in the practice of the present invention. A typical listing of nonionic classes, and species of these surfactants, is given in U.S. Pat. No. 3,929,678 issued to Laughlin and Heuring on Dec. 30, 1975. Further examples are given in “Surface Active Agents and detergents” (Vol. I and II by Schwartz, Perry and Berch). Additional nonionic surfactants can include those often defined as semi-polar nonionic surfactants, the disclosure of which in U.S. Patent Publication No. 2018-0110220 which is herein incorporated by reference in its entirety.

### Additional Functional Ingredients

The components of the solid cleaning compositions can further be combined with various functional components suitable for uses disclosed herein. In some embodiments, the solid cleaning compositions including the alkalinity source, alcohol alkoxylate surfactant and builder, and optionally the acid source, additional surfactants and/or polymers make up a large amount, or even substantially all of the total weight of the compositions. For example, in some embodiments few or no additional functional ingredients are disposed therein.

In other embodiments, additional functional ingredients may be included in the compositions. The functional ingredients provide desired properties and functionalities to the compositions. For the purpose of this application, the term “functional ingredient” includes a material that when dispersed or dissolved in a use and/or concentrate solution, such as an aqueous solution, provides a beneficial property in a particular use. Some particular examples of functional materials are discussed in more detail below, although the particular materials discussed are given by way of example only, and that a broad variety of other functional ingredients may be used. For example, many of the functional materials discussed below relate to materials used in cleaning. However, other embodiments may include functional ingredients for use in other applications.

In some embodiments, the solid cleaning compositions may include corrosion inhibitors, optical brighteners, defoaming agents, anti-redeposition agents, bleaching agents, solubility modifiers, dispersants, metal protecting agents, soil antiredeposition agents, stabilizing agents, preservatives, dissolution aids, corrosion inhibitors, additional builders/sequestrants/chelating agents, enzymes, aesthetic enhancing agents including fragrances and/or dyes, additional rheology and/or solubility modifiers or thickeners, hydrotropes or couplers, buffers, solvents, additional cleaning agents and the like.

In some embodiments, a corrosion inhibitor is included in the sold compositions.

In some embodiments, preservatives and/or dyes are included in the solid compositions.

According to embodiments of the invention, the various additional functional ingredients may be provided in a composition in the amount from about 0 wt-% and about 80 wt-%, from about 0 wt-% and about 70 wt-%, from about 0 wt-% and about 60 wt-%, from about 0 wt-% and about 40 wt-%, from about 0.1 wt-% and about 40 wt-%, from about 1 wt-% and about 40 wt-%, from about 1 wt-% and about 30 wt-%, from about 1 wt-% and about 20 wt-%, from about 1 wt-% and about 15 wt-%, or from about 1 wt-% and about 10 wt-%. In addition, without being limited according to the invention, all ranges recited are inclusive of the numbers defining the range and include each integer within the defined range.

In some embodiments, preservatives, biocides, and/or dyes are included in the solid compositions. Preferred preservatives include Kathon™ CG from Lanxess. Preferred biocides include Kathon™ 86F from Lanxess. In some embodiments, the solid compositions comprise from about 0 to about 1 wt-% of a dye, from about 0 to about 0.5 wt-% of a dye, from about 0 to about 0.1% of a dye, or from about 0.01 wt-% to about 0.1 wt-% of a dye. In some embodiments, the solid compositions comprise from about 0 to about 5 wt-% of a preservative, from about 0 to about 4 wt-% of a preservative, from about 0 to about 3% of a preservative, from about 0 to about 2 wt-% of a preservative, from 0 to about 1 wt-% of a preservative, or from about 0.01 wt-% to about 1.5 wt-% of a preservative. In some embodiments, the solid compositions comprise from about 0 to about 5 wt-% of a biocide, from about 0 to about 4 wt-% of a biocide, from about 0 to about 3% of a biocide, from about 0 to about 2 wt-% of a biocide, from 0 to about 1 wt-% of a biocide, or from about 0.01 wt-% to about 1.5 wt-% of a biocide.

In some embodiments, the solid compositions have a water content of less than about 15% by weight, less than about 10% by weight, less than about 5% by weight, less than about 1% by weight, less than about 0.5% by weight, or less than about 0.1% by weight. In some embodiments, the solid compositions do not include water as a raw material; however, water can be included in components of the solid compositions.

### Corrosion Inhibitors

The solid cleaning compositions can include one or more corrosion inhibitors for use for in cleaning of alkaline sensitive metals such as aluminum or aluminum containing alloys. The corrosion inhibitors must not negatively interfere with the solid and/or use composition stability Preferred corrosion inhibitors that maintain stability of the compositions include silicates and metasilicates, preferably alkali metal silicates and metasilicates, such as sodium silicate and sodium metasilicate. Anhydrous forms may be employed such as sodium metasilicate anhydrous.

Additional exemplary corrosion inhibitors include for example, an imidazoline compound, a quaternary ammonium compound, a pyridinium compound, or a combination thereof. Still further exemplary corrosion inhibitors can include for example a phosphate ester, monomeric or oligomeric fatty acid, alkoxylated amine, or mixture thereof. Disclosure of such exemplary corrosion inhibitors are set forth in U.S. application Ser. No. 16/775,417, the entire content of which are incorporated by reference herein in its entirety.

In some embodiments, the solid hard surface cleaning compositions include between about 0 wt-% to about 10 wt-% corrosion inhibitor, between about 0.01 wt-% to about 10 wt-% corrosion inhibitor, between about 0.01 wt-% to about 5 wt-% corrosion inhibitor, between about 0.1 wt-% to about 10 wt-% corrosion inhibitor, between about 0.1 wt-% to about 8 wt-% corrosion inhibitor, or between about 1 wt-% to about 8 wt-% corrosion inhibitor.

### Solid Compositions

The solid cleaning compositions are substantially homogeneous with regard to the distribution of ingredients throughout its mass and is dimensionally stable. The solid hard surface cleaning compositions are hardened compositions that will not flow and will substantially retain its shape under moderate stress or pressure or mere gravity. The degree of hardness of the solid hard surface cleaning composition may range from that of a fused solid block which is relatively dense and hard, for example, like concrete, to a consistency characterized as being a hardened paste. In addition, the term “solid” refers to the state of the solid hard surface cleaning composition under the expected conditions of storage and use. In general, it is expected that the solid hard surface cleaning composition will remain in solid form when exposed to temperatures of up to about 100° F. and preferably greater than about 120° F.

The solid hard surface cleaning composition may take forms including, but not limited to a pressed solid; a cast solid block; an extruded, molded or formed solid pellet, block, tablet, powder, granule, flake; or the formed solid can thereafter be ground or formed into a powder, granule, or flake.

In certain embodiments, the solid cleaning composition could be provided in the form of a unit dose. A unit dose refers to a composition unit sized so that the entire unit is used during a single cleaning cycle. When the solid hard surface cleaning composition is provided as a unit dose, it is preferably provided as a pressed solid, cast solid, an extruded pellet, or a tablet having a size of between approximately 1 gram and approximately 50 grams.

Beneficially the unit dose solid compositions provide an efficient and consistent dissolution rate on a time per mass basis. In an embodiment, the unit dose solid composition dissolves in 15 minutes or less, or preferably 10 minutes or less. As one skilled in the art will ascertain with the formulation of the solid compositions as described herein, a small size of the solid composition will result in a faster dissolution rate. In an embodiment, the solid compositions have a dissolution rate of about 1-5 grams over 1-10 minutes.

In preferred embodiments, the solid compositions have a dissolution rate of about 1 grams over 1-10 minutes, or about 1 grams over 1-5 minutes.

### Methods of Use

The solid compositions disclosed herein are particularly suitable for providing a solid having optimal dissolution rate for a customer or user of the solid composition to dissolve the solid for a use solution in a short period of time, such as less than about 20 minutes, less than about 15 minutes, or less than about 10 minutes.

The solid compositions dissolve to provide stable use compositions that quickly dissolve in water and form a stable, clear use solution. The stable use compositions do not exhibit precipitation upon storage and/or use. Moreover, in some embodiments the solid compositions do not require use of personal protective equipment (PPE) as they are safe for contact, including skin and eyes, e.g. based on individual use size and/or packaging.

The use compositions can be applied as concentrate compositions or further diluted. The use composition can be applied to a variety of surfaces as it is a multi-use formulation. The solid cleaning compositions are particularly suitable for cleaning hard surfaces. Suitable hard surfaces include those soiled with food soils, including food preparation surfaces that are heavily including with greasy soils, such as those in fryers, ovens, and various other cooking surfaces or adjacent surfaces. Various kitchen hygiene and hard surface applications are suitable for use of the use compositions.

Exemplary food preparation surfaces include surfaces in a restaurant, surfaces in a grocery store, and/or a household surfaces. In addition, various floor cleaning surfaces are included for use of the hard surface cleaning composition, including for example floors in kitchens, restaurants, the like, and/or drive-thrus.

### Embodiments

The present disclosure is further defined by the following numbered embodiments:

1. A solid cleaning composition comprising: an alkalinity source; an alcohol alkoxylate surfactant having 6 EO or less, or from 1 EO to 6 EO and greater than 2 PO; and a builder comprising an aminocarboxylic acid, a polycarboxylic acid, an aminophosphonate or combination thereof; and optionally, an acid source, additional surfactant and/or a polymer; wherein the composition readily dissolves into water at a dissolution rate of about 1 gram over 1-10 minutes.

2. The composition of embodiment 1, wherein the alkalinity source is at least one of alkali metal carbonate, alkali metal percarbonate, modified anhydrous percarbonate salt, alkali metal bicarbonate and/or alkali metal silicate, and preferably alkali metal hydroxide-free.

3. The composition of any one of embodiments 1-2, wherein the alcohol alkoxylate surfactant has 1 EO to 6 EO and 4 PO or greater, optionally 4 PO to 10 PO.

4. The composition of any one of embodiments 1-3, wherein the builder is an aminocarboxylic acid and/or polycarboxylic acid.

5. The composition of embodiments 4, wherein the aminocarboxylic acid is one or more of methylglycinediacetic acid (MGDA), N-hydroxyethyliminodiacetic acid, nitrilotriacetic acid (NTA), ethylenediaminetetraacetic acid (EDTA), N-hydroxyethyl-ethylenediaminetriacetic acid (HEDTA), diethylenetriaminepentaacetic acid (DTPA), ethylenediaminetetraproprionic acid, and triethylenetetraaminehexaacetic acid.

6. The composition of any one of embodiments 1-5, comprising from about 10-75 wt-% of the alkalinity source, from about 1-20 wt-% of the alcohol alkoxylate surfactant, and from about 0.1-50 wt-% of the builder.

7. The composition of any one of embodiments 1-6, further comprising an acid that is a polycarboxylic acid having between 2 and 4 carboxyl groups.

8. The composition of embodiment 7, wherein the polycarboxylic acid is citric acid or adipic acid.

9. The composition of embodiment 1, wherein the polymer is an acrylic acid polymer.

10. The composition of any one of embodiments 1-9, further comprising an alkali metal silicate and/or alkali metal metasilicate corrosion inhibitor.

11. The composition of any one of embodiments 7-10, comprising from about 20-75 wt-% of the alkalinity source, from about 2-20 wt-% of the alcohol alkoxylate surfactant, and from about 1-40 wt-% of the builder, and optionally comprising from about 1-75 wt-% of the polycarboxylic acid, from about 0.1-20 wt-% of the additional surfactant and/or polymer, and/or from about 0.01-10 wt-% of the corrosion inhibitor.

12. The composition of any one of embodiments 1-11, wherein the solid is a pressed solid, cast block, extruded, molded or formed solid pellet, block, tablet, powder, granule or flake.

13. The composition of embodiment 12, wherein the solid is a tablet having a mass of about 1 gram to about 50 grams, or preferably about 1 gram to about 10 grams.

14. The composition of embodiment 12, wherein the solid composition has dimensional stability measured by a growth exponent of less than about 15% for at least 8 weeks at 40° C.

15. A concentrate or use solution of the composition of any one of embodiments 1-14 formed by adding the solid composition of any one of embodiments 1-14 to a diluent.

16. A method of preparing a cleaning composition concentrate or use solution comprising: adding the solid cleaning composition of any one of embodiments 1-14 to a diluent to dissolve the solid cleaning composition into a concentrate or use solution; wherein the dissolution time for the solid cleaning composition is less than about 20 minutes, or preferably less than about 10 minutes.

17. The method of embodiment 16, wherein the diluent is water.

18. A method of cleaning a hard surface comprising: either adding the solid cleaning composition of any one of embodiments 1-14 to a diluent to dissolve the solid cleaning composition into a concentrate or use solution or providing the concentrate or use solution of claim 15 to a surface or article in need of cleaning; and removing soils form the surface or article.

19. The method of embodiment 18, where the surface is a hard surface.

20. The method of embodiment 18, wherein the dissolution time for the solid cleaning composition is less than about 20 minutes, or preferably less than about 10 minutes.

### EXAMPLES

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

The following materials were utilized in the Examples:
Acusol® 445 ND: a polycarboxylic acid, sodium salt of acrylic polymer (sodium polyacrylate), partially neutralized MW 16,000, available from Dow Chemical.
Aerosol OT-75®: sodium dioctyl sulfosuccinate, 75% in water/ethanol, available from Solvay.
Barlox 10S®: C10 amine oxide, 30%, available from Lonza.
Barlox 12®: C12 amine oxide, Lauramine Oxide 30% (lauryldimethlamine oxide (30%)), available from Lonza.
Bioterge® AS-90 Beads: alpha olefin sulfonate anionic surfactant (sodium C14-C16 alpha olefin sulfonate), AOS beads, available from Stepan.
Dehypon® LS 36: C12-14 alcohol alkoxylate, 3 EO, 6 PO, available from BASF Corporation.
Dehypon® LS 54: C12-14 alcohol alkoxylate, 5 EO, 4 PO, available from BASF Corporation.
Ecosurf™ EH-9: 2-ethyl hexanol, EO-PO, 9EO (PO proprietary), available from Dow Chemical.
Ecosurf™ EH-6: 2-ethyl hexanol EO-PO (proprietary), available from Dow Chemical.
Ecosurf™ EH-3: 2-ethyl hexanol EO-PO (proprietary), available from Dow Chemical.
Glucopon 215 UP®: C8-10 Polyglucoside, 63.5%, DP 1.5, available from BASF Corporation.
Glucopon 225 DK®: C8-10 Polyglucoside, 70%, DP 1.7, available from BASF Corporation.
Glucopon 425 N®: C8-10 Polyglucoside, 33.3%, C10-16 Polyglucoside, 16.7%, DP 1.5, available from BASF Corporation.
Lutensol® XL 70: C10-Guerbet alcohol alkoxylate, 7 EO, available from BASF Corporation.
Lutensol® XL 90: C10-Guerbet alcohol alkoxylate, 9 EO, available from BASF Corporation.
Surfonic® L24-7: C12-14 linear alcohol ethoxylate, 7 EO, available from Huntsman.
Surfonic® LF 17: C10-12 linear alcohol EO-PO (proprietary), available from Indorama.
Tomadol 91-6®: C9-11 linear alcohol ethoxylate, 6 EO, available from Evonik.
Trilon M® granules: trisodium salt of methylglycinediacetic acid, N, N-bis(carboxymethyl)-tri-sodium salt, available from BASF.
Commodity or widely commercially available materials from multiple sources: light ash (sodium carbonate), citric acid, sodium bicarbonate, and sodium silicate.

### Example 1

Dissolution Testing according to Surfactant Classification. Exemplary solid cleaning compositions were prepared as pressed tablets by pressing 3 g of powdered formula into a 20 mm tablet mold for 30 seconds at about 500 psi using a manual Carver press. The evaluated compositions were prepared according to Table 4. The following surfactant classes were tested: Alcohol alkoxylates (Dehypon LS 36, Dehypon LS 54, Ecosurf EH-9, Ecosurf EH-3, Lutensol XL 70, Lutensol XL 90); Linear alcohol ethoxylates (Tomadol 91-6, Surfonic L24-7); Alkyl polyglucosides (Glucopon 215 UP, Glucopon 225 DK, Glucopon 425 N); and Amine oxides (Barlox 10S, Barlox 12). Within the grouping of surfactants a single surfactant was included.

TABLE 4

| Description | wt-% |
|---|---|
| Light Ash | 40-60 |
| Trilon M ® Granules | 8-12 |
| Acusol ® 445 ND | 2-8 |
| Surfactant | 5-15 |
| Organic Acid | 10-15 |
| Sodium Bicarbonate | 1-5 |
| Sodium Silicate Powder | 1-5 |
| Total | 100 |

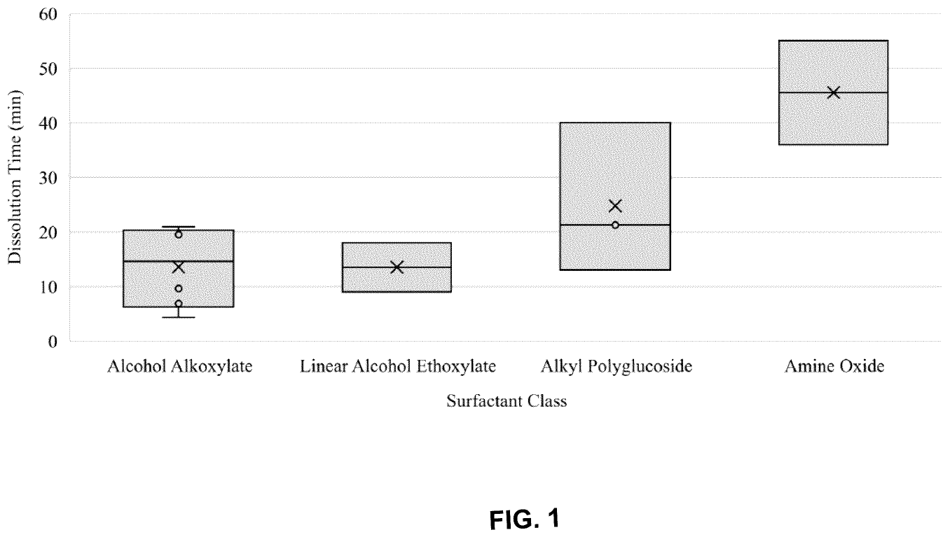

The tablets were then dropped into a 1-liter beaker filled with 500 mL of 5 gpg water and timed until the tablets were completely broken apart. Once the tablet was completely broken apart the timer was stopped and the dissolution time was recorded for each surfactant and the results. The results are shown in FIG. 1 grouping the surfactants into each classification.

As seen in FIG. 1, the average tablet dissolution time including different example surfactant classes relative to the alcohol alkoxylate class was evaluated. The average for the alcohol alkoxylate class was similar to the linear alcohol ethoxylate class and both of which were lower relative to the other tested surfactant classes.

These results show the benefit of including an alcohol alkoxylate surfactant in the solid cleaning composition. The desired dissolution time of less than about 20 minutes and preferably less than about 10 minutes provides a significant commercial advantage that is highly desirable by consumers.

### Example 2

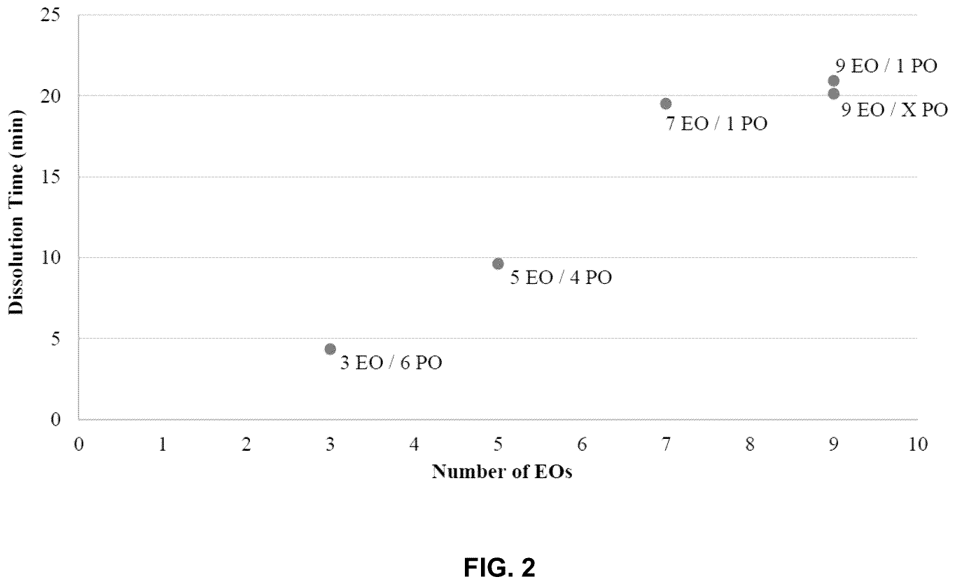

Additional dissolution testing was conducted to evaluate the alcohol alkoxylate structure on dissolution time. The data for alcohol alkoxylates shown in FIG. 2 was further extrapolated to evaluate the impact of the number of ethylene oxide groups/propylene oxide (EO/PO) groups in each surfactant with the evaluated surfactants listed. The evaluated compositions are shown in Table 5. Within the grouping of surfactants a single surfactant was included. The number of PO groups in the Ecosurf EH-9 surfactant is proprietary and not identified by the manufacturer.

TABLE 5

| Description | wt-% |
|---|---|
| Light Ash | 40-60 |
| Trilon M ® Granules | 8-12 |
| Acusol ® 445 ND | 2-8 |
| Surfactant | 5-15 |
| Dehypon LS 36, | |
| Dehypon LS 54, | |
| Ecosurf EH-9, | |
| Ecosurf EH-3, | |
| Lutensol XL 70, or | |
| Lutensol XL 90 | |
| Organic Acid | 10-15 |
| Sodium Bicarbonate | 1-5 |
| Sodium Silicate Powder | 1-5 |
| Total | 100 |

The results are shown in FIG. 2 where the number of EO/PO groups in each alcohol alkoxylate surfactants show that decreasing the number of EO groups results in faster dissolution rates. In many commercial embodiments a dissolution time of 20 minutes, 15 minutes, or even 10 minutes or less is preferred. The decreasing EO groups to 6 EO or less, namely 1 EO to 6 EO and increasing PO groups to 2 PO or more provided this desired dissolution time.

### Example 3

The stability of solid cleaning compositions was further evaluated as stability is an important characteristic within all solid cleaning products, including tablets. The formulations shown in Table 6 were evaluated using a single or combination of surfactants. Within each grouping of surfactants a single surfactant was included.

TABLE 6

| | Single | Two |
|---|---|---|
| | surfactant | surfactants |
| Description | wt-% | wt-% |
| Light Ash | 40-60 | 40-60 |
| Trilon M ® Granules | 8-12 | 8-12 |
| Acusol ® 445 ND | 2-8 | 2-8 |
| Dehypon LS 36, | 10-12 | |
| Dehypon LS 54, | | |
| Ecosurf EH-3, | | |
| Lutensol XL 70, | | |
| Lutensol XL 90, | | |
| Tomadol 91-6, or | | |
| Sufonic LF 17 | | |
| Aerosol OT-75 | | 3-5 |
| Ecosurf EH-3, | | 3-5 |
| Ecosurf EH-6, or | | |
| Ecosurf EH-9 | | |
| Organic Acid | 10-15 | 10-15 |
| Sodium Bicarbonate | 1-5 | 1-5 |
| Sodium Silicate Powder | 1-5 | 1-5 |
| Total | 100 | 100 |

Four tablets were pressed from each test formulation and each placed into their own glass jar with a tightly closed lid. The four samples were distributed into four different stability conditions: (1) Into a refrigerator; (2) Onto a benchtop to sit at room temperature; (3) Into a 65% humidity oven set to 40WC; and (4) Into a dry oven set to 50° C. The samples were checked weekly, and any observations noted. Stability testing concluded after 8-10 weeks.

The following criteria was used to evaluate if the test formula pass or failed stability:
Pass—No significant physical changes to the tablet. Small changes that were less severe than the Comparison Tablet were deemed acceptable.
Fail—Significant weeping, swelling, cracking, or any other visual obvious physical changes beyond cosmetic changes (e.g. color change would be considered cosmetic).

The results are summarized in Table 7 (excluding merely cosmetic observations).

TABLE 7

| Surfactant(s) within | | |
|---|---|---|
| Tablet Formula | Pass/Fail | Observations |
| Comparison Tablet | Pass | Weeks 1-2, 4-6 - 50 C. samples had |
| | | some weeping causing sticking |
| | | to container. |
| | | Weeks 1-3 - 40 C. Humidity samples |
| | | showed blooming/peeling/crumbling |
| | | behavior. |
| Ecosurf EH-3 | Pass | |
| Surfonic LF 17 | Pass | Week 1 - 40 C. humidity samples |
| | | had slight sticking to container |
| | | but not sticky to the touch. Not |
| | | observed after week 1. |
| Dehypon LS 36 | Pass | Week 1 - a 40 C. humidity sample |
| [3 EO, 6 PO] | | had slight sticking to container |
| | | but not sticky to the touch. Not |
| | | observed after week 1. |
| Dehypon LS 54 | Pass | Week 1 - 40 C. humidity samples |
| [5 EO, 4 PO] | | had slight sticking to container |
| | | but not sticky to the touch. Not |
| | | observed after week 1. |
| Lutensol XL 70 | Fail | Significant weeping at room |
| [7 EO, 1 PO] | | temperature after two days. |
| Lutensol XL 90 | Fail | Significant weeping at room |
| [9 EO, 1 PO] | | temperature after two days. |
| Tomadol 91-6 | Fail | Significant weeping at room |
| [6 EO] | | temperature after one day. |
| Ecosurf EH-3 and | Pass | |
| Aerosol OT-75 | | |
| Ecosurf EH-6 and | Pass | Weeks 1-2 - room temperature |
| Aerosol OT-75 | | samples were slightly sticky. |
| Ecosurf EH-9 and | Pass | Weeks 1-3 - room temperature |
| Aerosol OT-75 | | samples were slightly sticky. |

When linear alcohol ethoxylates, such as Tomadol 91-6, were used in the tablet, significant weeping was observed within a relatively short time. Similarly, alcohol alkoxylates that contained a very low number of PO groups, such as Lutensol XL 70, also resulted in significant weeping of the tablet. Higher PO group alcohol alkoxylates however, such as Dehypon LS 36, produced a stable tablet. This analysis shown in Table 8 identified that surfactants with a higher number of PO groups, greater than 1 PO, produced a stable tablet. In particular the surfactants having 4 PO provided stable solids.

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized and structural changes may be made without departing from the scope of the present disclosure. All publications discussed and/or referenced herein are incorporated herein in their entirety. The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

What is claimed is:

1. A solid cleaning composition comprising:
(a) an alkalinity source;
(b) an alcohol alkoxylate surfactant having 6 EO or less and greater than 2 PO; and
(c) a builder comprising an aminocarboxylic acid, a polycarboxylic acid, an aminophosphonate or combination thereof; and
(d) optionally, an acid source, additional surfactant and/or a polymer;
wherein the composition readily dissolves into water at a dissolution rate of about 1 gram over 1-10 minutes.

2. The composition of claim 1, wherein the alkalinity source is at least one of alkali metal carbonate, alkali metal percarbonate, modified anhydrous percarbonate salt, alkali metal bicarbonate and/or alkali metal silicate, and preferably alkali metal hydroxide-free.

3. The composition of claim 1, wherein the alcohol alkoxylate surfactant has 1 EO to 6 EO and 4 PO or greater, optionally 4 PO to 10 PO.

4. The composition of claim 1, wherein the builder is an aminocarboxylic acid and/or polycarboxylic acid.

5. The composition of claim 4, wherein the aminocarboxylic acid is one or more of methylglycinediacetic acid (MGDA), N-hydroxyethyliminodiacetic acid, nitrilotriacetic acid (NTA), ethylenediaminetetraacetic acid (EDTA), N-hydroxyethyl-ethylenediaminetriacetic acid (HEDTA), diethylenetriaminepentaacetic acid (DTPA), ethylenediaminetetraproprionic acid, and triethylenetetraaminehexaacetic acid.

6. The composition of claim 1, comprising from about 10-75 wt-% of the alkalinity source, from about 1-20 wt-% of the alcohol alkoxylate surfactant, and from about 0.1-50 wt-% of the builder.

7. The composition of claim 1, further comprising an acid that is a polycarboxylic acid having between 2 and 4 carboxyl groups.

8. The composition of claim 7, wherein the polycarboxylic acid is citric acid or adipic acid.

9. The composition of claim 1, wherein the polymer is an acrylic acid polymer.

10. The composition of claim 1, further comprising an alkali metal silicate and/or alkali metal metasilicate corrosion inhibitor.

11. The composition of claim 7, comprising from about 20-75 wt-% of the alkalinity source, from about 2-20 wt-% of the alcohol alkoxylate surfactant, and from about 1-40 wt-% of the builder, and optionally comprising from about 1-75 wt-% of the polycarboxylic acid, from about 0.1-20 wt-% of the additional surfactant and/or polymer, and/or from about 0.01-10 wt-% of the corrosion inhibitor.

12. The composition of claim 1, wherein the solid is a pressed solid, cast block, extruded, molded or formed solid pellet, block, tablet, powder, granule or flake.

13. The composition of claim 12, wherein the solid is a tablet having a mass of about 1 gram to about 50 grams, or preferably about 1 gram to about 10 grams.

14. The composition of claim 12, wherein the solid composition has dimensional stability measured by a growth exponent of less than about 15% for at least 8 weeks at 40° C.

15. A concentrate or use solution of a composition formed by adding the solid composition of claim 1 to a diluent.

16. A method of preparing a cleaning composition concentrate or use solution comprising:
adding the solid cleaning composition of claim 1 to a diluent to dissolve the solid cleaning composition into a concentrate or use solution;
wherein the dissolution time for the solid cleaning composition is less than about 20 minutes.

17. The method of claim 16, wherein the diluent is water.

18. A method of cleaning a hard surface comprising:
adding a solid cleaning composition to a diluent to dissolve the solid cleaning composition into a concentrate or use solution, or
providing the concentrate or use solution of claim 15 to a surface or article in need of cleaning; and
removing soils from the surface or article.

19. The method of claim 18, where the surface is a hard surface.

20. The method of claim 18, wherein the dissolution time for the solid cleaning composition is less than about 20 minutes.
